(19) United States
(12) Patent Application Publication
(10) Pub. No.: US 2013/0079007 A1
(43) Pub. Date: Mar. 28, 2013

(54) NEIGHBOR CELL LIST BASED ON HANDOVER MESSAGE

(71) Applicants: Sumeeth NAGARAJA, San Diego, CA (US); Farhad MESHKATI, San Diego, CA (US); Damanjit SINGH, San Diego, CA (US); Vinay CHANDE, San Diego, CA (US); Andrei Dragos RADULESCU, San Diego, CA (US); Mehmet YAVUZ, San Diego, CA (US)

(72) Inventors: Sumeeth NAGARAJA, San Diego, CA (US); Farhad MESHKATI, San Diego, CA (US); Damanjit SINGH, San Diego, CA (US); Vinay CHANDE, San Diego, CA (US); Andrei Dragos RADULESCU, San Diego, CA (US); Mehmet YAVUZ, San Diego, CA (US)

(73) Assignee: QUALCOMM incorporated, San Diego, CA (US)

(21) Appl. No.: 13/427,683

(22) Filed: Mar. 22, 2012

Related U.S. Application Data
(60) Provisional application No. 61/467,805, filed on Mar. 25, 2011.

(51) Int. Cl. H04W 36/00

(52) U.S. Cl. CPC H04W 36/0005
USPC 455/436

(57) ABSTRACT

A neighbor cell list for a cell is maintained based on a received handover message that identifies at least one physical layer identifier. For example, the handover message may include measurement report messages (MRMs) generated by the access terminal being handed over. As another example, the handover message may include a neighbor cell list that is associated with the access terminal. The measurement report messages and the neighbor cell list associated with the access terminal will identify physical layer identifiers of cells in the vicinity of the source cell and, in some cases, in the vicinity of the access terminal being handed over. Upon receipt of the handover message, the neighbor cell list for the target cell is updated based on the physical layer identifiers identified by the handover message.

### CLAIM OF PRIORITY

This application claims the benefit of and priority to commonly owned U.S. Provisional Patent Application No. 61/467,805, filed Mar. 25, 2011, and assigned Attorney Docket No. 111359P1, the disclosure of which is hereby incorporated by reference herein.

### BACKGROUND

### Field

This application relates generally to wireless communication and more specifically, but not exclusively, to neighbor cell list creation and management for access points.

### Introduction

A wireless communication network may be deployed over a defined geographical area to provide various types of services (e.g., voice, data, multimedia services, etc.) to users within that geographical area. In a typical implementation, macro access points (e.g., each of which corresponds to one or more macrocells) are distributed throughout a network to provide wireless connectivity for access terminals (e.g., cell phones) that are operating within the geographical area served by the network.

A macro network deployment is carefully planned, designed and implemented to offer good coverage over the geographical area. Even with such careful planning, however, such a deployment may not completely accommodate channel characteristics such as path loss, fading, multipath, shadowing, etc., in indoor and potentially other environments. Consequently, macrocell users may face coverage issues (e.g., call outages and quality degradation) indoors and at other locations, resulting in poor user experience.

To supplement conventional network access points (e.g., macrocells) and provide enhanced performance, low-power access points may be deployed to provide coverage for access terminals over relatively small coverage areas. For example, a low-power access point installed in a user's home or in an enterprise environment (e.g., commercial buildings) may provide voice and high speed data service for access terminals supporting cellular radio communication (e.g., CDMA, WCDMA, UMTS, LTE, etc.).

In various implementations, low-power access points may be referred to as, for example, femtocells, femto access points, home NodeBs, home eNodeBs, access point base stations, picocells, etc. In some implementations, such low-power access points are connected to the Internet and the mobile operator's network via a Digital Subscriber Line (DSL), cable internet access, T1/T3, or some other suitable means of connectivity. In addition, a low-power access point may offer typical access point functionality such as, for example, Base Transceiver Station (BTS) technology, a radio network controller, and gateway support node services.

In practice, femtocells may be deployed with minimal planning. Consequently, it is desirable for femtocells to be capable of self-configuring and self-organizing in terms of choosing available radio resources such as, for example, frequency and physical layer identifiers (e.g., primary scrambling codes (PSCs)), and in terms of identifying neighbor cells. However, creating and managing an accurate neighbor cell list (NCL) at a femtocell in unplanned deployments tends to be a relatively challenging task. In contrast with macrocells, the location of femtocell installations may not be known a priori to the operator. Moreover, a femtocell is not necessarily fixed in location during its operating life. For example, a femtocell may be initially installed near a window in an enterprise and later moved indoors due to interference considerations. As another example, a femtocell installed in an apartment unit may be carried to another apartment in another city. At different locations of femtocell installation, the surrounding radiofrequency (RF) conditions and neighbor access points (e.g., macrocells, picocells and femtocells) will likely be different and, therefore, the NCL at the femtocell should be reconstructed. Furthermore, due to RF mismatch, in which the cells that are seen at the femtocell may be different from the cells seen by an access terminal served by the femtocell at various locations of the access terminal, the NCL at the femtocell may not be sufficiently accurate (e.g., for conditions near the outer boundaries of the coverage area).

It is important that the NCL, at the femtocell, is configured correctly. That is, an NCL (e.g., for intra-frequency, inter-frequency and inter-Radio Access Technology (RAT)) should contain the physical layer identifiers of all nearby access points (macrocells, picocells, and femtocells).

Incorrect configuration of an NCL may result in poor performance in idle and active mode mobility. Regarding active mobility, an access terminal that is connected to the femtocell and moving out of the femtocell coverage area will likely experience handover failures and call drops. Regarding idle mobility, an access terminal that is camping on the femtocell and moving out the femtocell coverage may briefly go out-of-service during which it cannot receive any pages from the network.

Furthermore, providing an accurate construction of radiofrequency (RF) interference characteristics in the desired femtocell coverage area may require having a correct NCL at the femtocell. An incorrect NCL may result in incorrect representation of macrocell RF interference characteristics in the desired femtocell coverage area. This is applicable to all methods that rely on access terminal reports to construct a macrocell RF interference profile in the surrounding area. For instance, macrocell RF information is used in femtocell downlink transmit power calibration algorithms, in algorithms that limit uplink interference to macrocells by capping femtocell access terminal transmit power level, and so on.

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to maintaining a neighbor cell list (NCL) for wireless communication cells (e.g., macrocells, picocells, femtocells, etc.). The NCL for a given cell generally includes, at a minimum, a physical layer identifier (e.g., a primary scrambling code in UMTS) associated with each neighbor cell that is near the cell. With respect to the cell for which the NCL is being maintained, the neighbor cells may be intra-frequency, inter-frequency, or inter-RAT (Radio Access Technology).

The disclosure relates in some aspects to maintaining (e.g., creating and managing) an NCL for a cell based on received handover messages. For example, in conjunction with handover of an access terminal (e.g., a UE, a mobile, etc.) to a cell, a handover message may be sent by a source cell. Upon receiving a handover message, a determination is made as to whether the message includes any physical layer identifiers that are not in the cell's current NCL. If the message does include such a physical layer identifier, the physical layer identifier may be added to the NCL.

Accordingly, in some aspects, a communication scheme implemented according to the teachings herein may involve the functions that follow. A handover message that indicates that an access terminal is being handed-over to a cell is received at a network entity (e.g., a radio network entity or a core network entity). This handover message includes at least one physical layer identifier. The at least one physical layer identifier is added to a neighbor cell list for the cell as a result of receiving the handover message.

In some embodiments, a handover message includes at least one measurement report message generated by the access terminal being handed-over. Accordingly, any physical layer identifiers included in the measurement report message(s) may be added to the cell's NCL.

In some embodiments, a handover message includes at least one NCL that was provided to the access terminal being handed-over. Accordingly, any physical layer identifiers included in the received NCL(s) may be added to the cell's NCL.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of several sample aspects of a communication system wherein an NCL for a cell is maintained based on handover messages;

FIG. 2 is a flowchart of several sample aspects of operations that may be performed in conjunction with maintaining an NCL based on handover messages;

FIG. 3 is a flowchart of several sample aspects of operations that may be performed to maintain an NCL for a cell based on handover messages;

FIG. 4 is a flowchart of several sample aspects of operations that may be performed in conjunction with provisioning an access terminal to conduct measurements of physical layer identifiers received in a handover message;

FIG. 5 is a flowchart of several sample aspects of operations that may be performed to prioritize physical layer identifiers for an NCL;

FIG. 6 is a flowchart of several sample aspects of operations that may be performed to maintain an NCL based on co-located cell information;

FIG. 7 is a flowchart of several sample aspects of operations that may be performed to maintain an NCL based on information received from a network entity;

FIG. 8 is a simplified block diagram of several sample aspects of components that may be employed in communication nodes;

FIG. 9 is a simplified diagram of a wireless communication system;

FIG. 10 is a simplified diagram of a wireless communication system including femto nodes;

FIG. 11 is a simplified diagram illustrating coverage areas for wireless communication;

FIG. 12 is a simplified block diagram of several sample aspects of communication components; and

FIGS. 13 and 14 are simplified block diagrams of several sample aspects of an apparatus configured to maintain an NCL as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

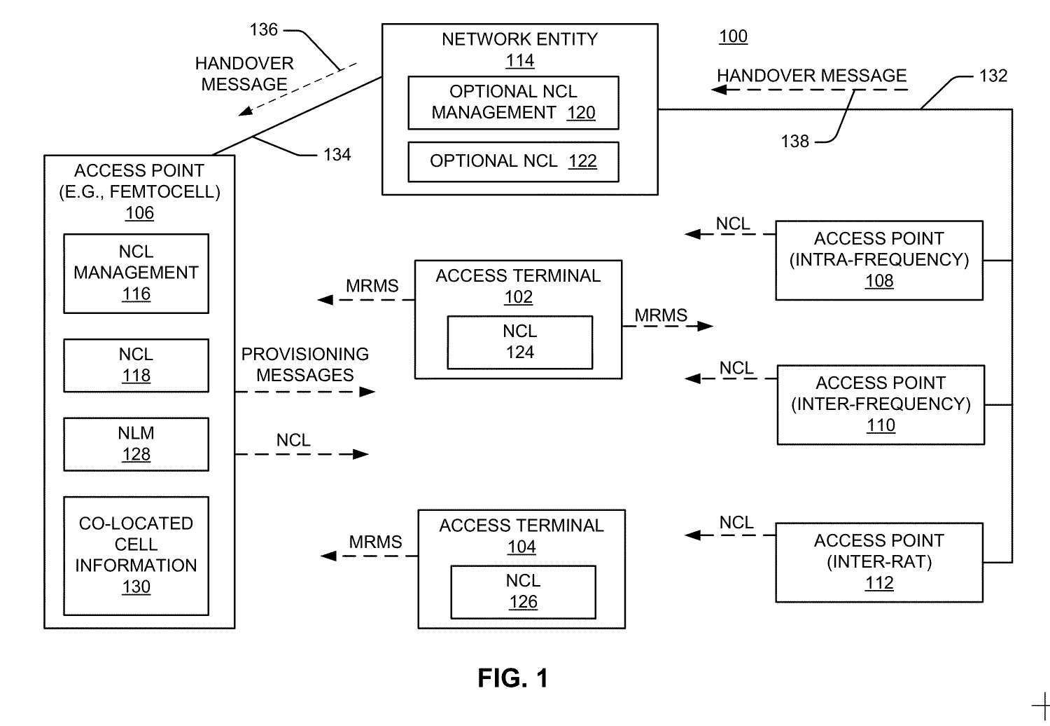

FIG. 1 illustrates several nodes of a sample communication system 100 (e.g., a wireless communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, macrocells, femtocells, and so on, while access terminals may be referred to or implemented as user equipment (UEs), mobiles, and so on.

Access points in the system 100 provide access to one or more services (e.g., network connectivity) for one or more wireless terminals (e.g., access terminals 102 and 104) that may be installed within or that may roam throughout a coverage area of the system 100. For example, at various points in time the access terminal 102 may connect to an access point 106, an access point 108, an access point 110, an access point 112, or some access point in the system 100 (not shown). Similarly, at various points in time the access terminal 104 may connect to any of these access points.

The access points depicted in FIG. 1 may employ different frequencies and/or different radio access technologies (RATs). For example, relative to the access point 106, the access point 108 is intra-frequency (e.g., operating on the same carrier frequency). Relative to the access point 106, the access point 110 is inter-frequency (e.g., operating on a different carrier frequency). Relative to the access point 106, the access point 112 is inter-RAT (e.g., employing a different RAT).

As represented in a simplified manner by the lines 132 and 134, each of the access points may communicate with one or more network entities (represented, for convenience, by a network entity 114), including each other, to facilitate wide area network connectivity. These network entities may take various forms such as, for example, one or more radio and/or core network entities. Thus, in various implementations the network entities may represent functionality such as at least one of: network management (e.g., via an operation, administration, management, and provisioning entity), call control, session management, mobility management, gateway functions, interworking functions, radio resource management, or some other suitable network functionality. Also, two or more of these network entities may be co-located and/or two or more of these network entities may be distributed throughout a network. Various communication technologies may be employed by a given network entity to communicate with other network entities (e.g., intra-RAT and/or inter-RAT). In addition, the network entities may comprise part of a Session Initiation Protocol (SIP) based circuit-switched network, an Interoperability Specification (IOS) based circuit-switched network, a packet-switched network, or some other suitable wireless communication network.

Some of the access points (e.g., the access points 106 and 108) in the system 100 may comprise low-power access points. A low-power access point will have a maximum transmit power that is less (e.g., by an order of magnitude) than a maximum transmit power of any macro access point in a given coverage area. In some embodiments, low-power access points such as femtocells may have a maximum transmit power of 20 dBm or less. In some embodiments, low-power access points such as picocells may have a maximum transmit power of 24 dBm or less. In contrast, a macrocell may have a maximum transmit power of 43 dBm. It should be appreciated, however, that these or other types of low-power access points may have a higher or lower maximum transmit power in other embodiments. For convenience, low-power access points may be referred to as femtocells or femto access points in the discussion that follows. Thus, it should be appreciated that any discussion related to femtocells or femto access points herein may be equally applicable, in general, to low-power access points or other types of access points.

As mentioned above, it is important to provide an accurate NCL for a femtocell. In some scenarios (e.g., due to blockage caused by buildings or other structures), the access point 106 is unable to detect radio signals from neighbor access points (e.g., the access points 108-112), and therefore will not be able to correctly populate the NCL list for an access terminal (e.g., the access terminal 102) if the access point 106 relies only on its own detection capabilities. The present disclosure, among other things, provides methodologies for the access point 106 (or other access points) to make up for deficiencies in the ability of the access point to detect neighbor access points due to blocking, an invisible node issue, or other reception limitations.

In some aspects, a framework is provided to construct and manage a neighbor cell list for an access point (e.g., a femtocell, a picocell or a macrocell). In a sample implementation, the neighbor cell list (NCL) consists of primary scrambling codes (PSCs) of neighbor access points that are operating in a frequency allocated to the operator (e.g., intra-frequency, inter-frequency and inter-RAT). The disclosure relates in some aspects to enabling an access point to self-construct and correctly manage an NCL to facilitate active and idle mobility and interference management.

The application relates in some aspects to maintaining (e.g., creating and managing) an NCL for a cell based on received handover messages. As used herein, handover may relate to a handover from a macrocell to a femtocell (i.e., hand-in), handover from a femtocell to a femtocell, handover from a femtocell to a macrocell (i.e., hand-out), or handover between other types of cells.

In the example of FIG. 1, the access point 106 includes NCL management functionality 116 for maintaining an NCL 118 for the access point 106. The access point 106 broadcasts the physical layer identifiers of the NCL 118 so that access terminals (e.g., access terminals 102 and 104) in the vicinity of the access point 106 may each maintain a record of the NCL (e.g., the NCLs 124 and 126, respectively) for handover, reselection, or other purposes.

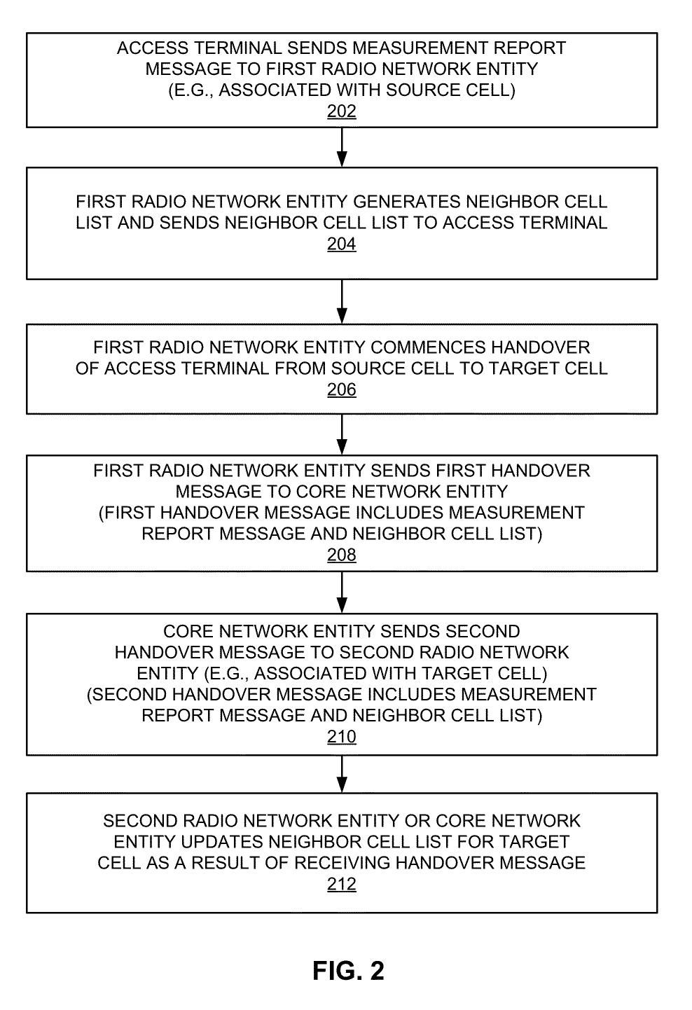

In conjunction with maintaining the NCL 118, the NCL management functionality 116 determines whether physical layer identifiers identified in a received handover message should be added to the NCL 118. As depicted in FIG. 1, the access point 106 receives a handover message 136 from the network entity 114 in conjunction with handover of an access terminal (e.g., the access terminal 102) to the access point 106. Sample operations relating to such a handover procedure are described in more detail below in conjunction with FIG. 2.

In some embodiments, to determine whether a received physical layer identifier should be added to the NCL 118, the access point 106 transmits provisioning messages to access terminals (e.g., access terminal 102) being served by the access point 106. The provisioning messages instruct the access terminals to conduct intra-frequency, inter-frequency, or inter-RAT measurements. For example, the access terminals may detect messages from nearby access points (e.g., the neighbor access points 108-112), derive physical layer identifier information from these signals, and report back the results of the measurements (e.g., via measurement report messages (MRMs)) to the access point 106. In some cases, the access terminals decode system information broadcast by a given neighbor access point, where the system information includes the NCL for that neighbor access point. In other cases, the access terminals detect the physical layer identifier broadcast by the neighbor access point. In any event, the NCL management functionality 116 may use the physical layer identifier information provided by the MRMs to verify whether a physical layer identifier identified by the handover message is detectable.

In some embodiments, the access point 106 includes functionality to maintain the NCL 118 based on network listen operations. For example, the access point 106 may include a network listen module (NLM) 128 that receives signals from nearby access points (e.g., the neighbor access points 108-112). In this way, the access point 106 may directly acquire information from these access points. Accordingly, the NCL management functionality 116 may use the physical layer identifier information acquired by the NLM 128 to verify whether a physical layer identifier identified by the handover message is detectable.

In some embodiments, the access point 106 includes functionality to maintain the NCL 118 based on co-located cell information 130. For example, the access point 106 may maintain the co-located cell information 130 in a memory component and use this information to determine whether to include the physical layer identifier of co-located cells in the NCL 118.

In some embodiments, the NCL management functionality 116 cooperates with NCL management functionality 120 of the network entity 114 to acquire physical layer identifier information maintained by the NCL management functionality 120. For example, in some embodiments, the NCL management functionality 116 sends an identifier (e.g., GPS coordinates, a PSC, etc.) associated with the access point 106 to the NCL management functionality 120. Based on this identifier, the NCL management functionality 120 identifies any access points (e.g., identifies the cells of the access points) that are in a neighborhood associated with the access point 106 (e.g., within a defined geographical area, within a defined distance, within a location area, within a routing area, within a defined number of network hops, etc.). The NCL management functionality 120 then sends any physical layer identifiers associated with the identified access points (e.g., physical layer identifiers and/or NCLs of the access points) to the NCL management functionality 116. In this way, physical layer identifier information maintained by the network may be added to the NCL 118.

In some embodiments, the NCL management functionality 120 of the network entity 114 maintains an NCL 122 on behalf of the access point 106. For example, rather than have the access point 106 process physical layer identifier information received via a handover message, the NCL management functionality 120 may maintain the NCL 122 based on handover messages received by the network entity 114 and send the resulting NCL to the access point 106. Alternatively, the access point 106 may forward received handover information to the network entity 114 to enable the NCL management functionality 120 may maintain the NCL 122.

Sample operations of the system 100 will now be described in more detail in conjunction with the flowchart of FIG. 2. In particular, these operations relate to the generation and processing of handover messages to facilitate maintaining an NCL.

The maintenance of a neighbor cell list may be performed by different entities in different embodiments. In some embodiments, these operations are performed by a radio network entity (e.g., an access point such as a femtocell) associated with a cell for which the NCL is being maintained. In this case, the radio network entity processes received handover messages to maintain the NCL. In other embodiments, the operations of FIG. 2 are performed by a network entity (e.g., a core network entity) that maintains the NCL for a cell. In this case, the network entity processes received handover messages to maintain the NCL and sends the updated NCL to the cell (e.g., to an access point (base station) associated with the cell).

Blocks 202 and 204 relate to the generation of physical layer identifier information that will be included in a handover message. These operations are performed prior to handover of an access terminal.

As represented by block 202, prior to handover, an access terminal will be requested to conduct measurements to detect nearby cells. Consequently, the access terminal will send measurement report messages to a network entity. These measurement reports will identify the physical layer identifiers of any cells detected by the access terminal. In a typical embodiment, this network entity is a radio network entity associated with a cell (e.g., a femtocell or an SRNC associated with a NodeB).

As represented by block 204, the network entity generates a neighbor cell list and sends the neighbor cell list to the access terminal. The access terminal uses this neighbor cell list for mobility operations (e.g., to conduct a search for specific physical layer identifiers). This neighbor cell list will, in general, identify the physical layer identifiers of any cells that were detected in the vicinity of the access terminal (e.g., in the vicinity of the cell currently serving the access terminal).

Blocks 206-210 relate to handover operations. As represented by block 206, at some point in time, a determination is made to handover the access terminal from its current serving cell (i.e., the source cell) to a target cell. For example, if the measurements made by the access terminal indicate that the access terminal will be better served by the target cell, the network entity (e.g., an SRNC) will commence handover of the access terminal to the target cell.

As represented by block 208, the network entity will therefore send a handover message to another network entity. This other network entity may comprise, for example, a core network entity (e.g., a Home NodeB Gateway). The handover message will include: 1) the measurement report message(s) generated by the access terminal; and/or 2) the neighbor cell list for the access terminal. These measurement report messages and this neighbor cell list will identify the physical layer identifiers discussed above. Examples of the handover message sent at block 208 include, without limitation, a RANAP Relocation Request message, an Enhanced Relocation Information Request message, a Relocation Required message, or a Handover Request message (e.g., for LTE).

As represented by block 210, after receiving the handover message, the other network entity will send an appropriate handover message to the network entity associated with the target cell. The recipient network entity may be, for example, a radio network entity associated with the target cell (e.g., a femtocell, or an SRNC associated with a NodeB). The handover message sent at block 210 includes the measurement report messages and/or the neighbor cell list discussed above. In some embodiments, the sending of the handover message at block 210 simply involves forwarding the received handover message (i.e., the handover message sent at block 208). In other embodiments, the sending of the handover message at block 210 involves sending another handover message that includes information from the received handover message (i.e., the handover message sent at block 208). Examples of the handover message sent at block 210 include, without limitation, a RANAP Relocation Request message, an Enhanced Relocation Information Request message, a Relocation Required message, or a Handover Request message (e.g., for LTE).

Block 212 relates to maintaining the neighbor cell list for the target cell. As discussed above, this operation may be performed by, for example, a radio network entity (e.g., a femtocell or an SRNC associated with a NodeB), a core network entity (e.g., a Home NodeB Gateway), or some other suitable entity.

In either of these cases, the recipient network entity updates the neighbor cell list as a result of receiving a handover message. For example, if the neighbor cell list does not already include one or more of the physical layer identifiers identified by the handover message, the recipient entity may verify whether the access terminal (or the target cell) is able to receive signals of sufficient quality from the cells associated with the identified physical layer identifiers and, if so, add these cells to the neighbor cell list.

With the above overview in mind, several examples of NCL maintenance will now be described in more detail. For purposes of illustration, this example is described in the context of a UMTS system. It should be appreciated, however, that the teachings herein may be employed in other types of wireless communication systems (e.g., GSM, LTE, cdma2000, etc.).

The disclosure relates in some aspect to the creation and management of NCLs. In the examples that follow, the creation of an NCL includes generating a set of candidate PSCs.

As discussed herein, for both active and idle mobility management, it is important to provide the correct set of PSCs to a UE for measurement. Based on the measurements or measurement report messages (MRMs), the UE or femtocell may take appropriate action as discussed herein. By providing an accurate list of PSCs to the UE in this manner, handover delays may be reduced. In some aspects, NCL management as taught herein may employ methods of ranking cells and/or creating a preferred list of PSCs that may be used for mobility management of idle or active UEs and/or for interference management.

To construct an accurate NCL at the femtocell (e.g., under RF blocking conditions), one or more of the methods that follow may be used. That is, the NCL may be constructed using any one or all of the described the methods, or some combination of the methods. The specific methods described are provided by way of example only, and should not be understood as limiting the novel features described herein to the specific examples described. The methods may be performed by a femtocell or other base station in cooperation with one or more mobile entities within radio range. In the alternative, or in addition, some features may be implemented at other network entities to support or perform certain aspects of the methods. As used herein, the term “intra-frequency” refers to neighbor frequencies that are the same as used by the femtocell of interest, assumed to be in the same RAT as used by the femtocell. The term “intra-frequency” refers to neighbor frequencies that are not the same as the frequency used by the femtocell, which may include inter-RAT frequencies unless the context clearly would exclude such a possibility. The term “Inter-RAT” refers to neighbor RATs that are not the same as the RAT used by the femtocell of interest.

### Creation of NCL

To construct an accurate NCL at the Home NodeB (HNB) for a femtocell, the operations described herein may be performed by the HNB and/or the operator (e.g., a macro Radio Network Controller (RNC)). In one embodiment, the NCL creation technique may be based on information relating to an active hand-in from a macrocell to a femtocell. Suppose that a UE is on an active call with a macrocell. As the UE approaches a femtocell, it is handed over from the macrocell to the femtocell. The handover message from the macrocell to the femtocell may include a relocation transparent container that carries a UE measurement report. The relocation transparent container also may include the NCL with which the serving RNC (SRNC) has configured the UE. This NCL may include, for example, intra-frequency cell information, intra-frequency cell information on a secondary uplink frequency, inter-frequency cell information, and inter-RAT information. This list may be referred to as an SRNC NCL in the discussion that follows.

### Procedure at UE

The UE procedure described herein may be followed by various types of UEs, including legacy UEs. During an active call, a UE may be connected to the macro RNC and may be in a Cell_DCH (dedicated channel) state. The macro RNC may request the UE to measure intra-frequency and inter-frequency PSCs provided in the NCL. The UE's measurement report, which is sent to the macro RNC, may contain intra-frequency and/or inter-frequency PSCs and other measurement parameters (e.g., measurements of inter-RAT neighbor cells). It is noted that the intra-frequency and the inter-frequency PSCs may be obtained in the same MRM using additional fields. Furthermore, the macrocell may enable Detected Cell reporting for intra-frequency cells.

### Procedure at Macro RNC/HNB Gateway

The macro RNC, after obtaining the UE's MRMs, may retrieve the necessary information and initiate an inter-RNC hard handoff procedure. Furthermore, the macro RNC may pass MRMs, as well as the SRNC NCL, to the HNB gateway for the target. Similar to the inter-RNC hard handoff procedure, the HNB gateway may extract the HNB/cell identification and pass the MRMs and/or the SRNC NCL to the target RNC(s) (e.g., a femtocell).

### Procedure at HNB of Femtocell

With respect to intra-frequency candidate PSCs, the HNB may extract PSCs that are listed along with femtocell PSCs in the MRMs to create a list of candidate intra-frequency cells.

With respect to inter-frequency candidate PSCs, for each downlink UTRA Absolute Radio Frequency Channel Number (UARFCN) reported, the HNB may extract the downlink UARFCN and the corresponding PSCs from the MRM to create a list of candidate inter-frequency cells. The HNB may also extract the inter-frequency PSCs from the SRNC NCL or the like for this list.

With respect to inter-RAT candidate cells, for each RAT reported, the HNB may extract identifiers from the MRM to create a list of candidate inter-RAT cells. The HNB may also extract the inter-RAT cells from the SRNC NCL for this list.

Accordingly, the femtocell NCL may be constructed based on information collected as described above (e.g., as a proper or improper subset of the neighbors of the femtocell).

It is noted that active hand-in to a femtocell could occur from different macrocells. The HNB for the femtocell may thus store the list of candidate PSCs obtained from each active hand-in and then consider a union over time of all PSCs obtained from the SRNC(s). It is also noted that the femtocell could assign a higher priority to neighbor cells reported by the UE in the MRM, as compared to those cells from the SRNC NCL that were not reported in the MRM.

In related aspects, the HNB may report its Global Positioning System (GPS) coordinates, IP address, PSCs, and/or cell ID(s) of nearby cells (if available) to a HNB Management System (HMS). The HMS may identify PSCs and cell IDs of Node Bs that are located in a neighborhood (e.g., within a defined distance) of the femtocell (e.g., based on their GPS coordinates). The HMS may identify neighbor macro and/or pico Node Bs and use their (e.g., broadcast) NCL information or PSC ranges. The HMS may identify pilot/identity (e.g., PSC/PCI/BCCH ARFCN) ranges that nearby cells may use. Such information may be sent to the HMS to construct the femtocell's NCL.

As a specific example, a femtocell may receive PSCs for the NCL from a network entity based on geographic location information for the femtocell. This geographic location may be obtained in any suitable fashion, such as using a GPS receiver or other locating technique. The network entity may determine likely neighbors from the geographic location information, obtain PSCs for the likely neighbors, and transmit them to the femtocell for populating an NCL.

As used herein, the term HMS is used in a generic sense, to encompass any one of a Home NodeB (HNB) Management System (as used by, e.g., Femto Forum or 3GPP); and any management/reference entity including, for example, an internal femtocell (e.g., HNB) database, possibly preconfigured, a location management database (e.g., GPS assistance) possibly adapted to provide neighbor cell information, or nearby femtocells/RNCs, with which the femtocell may exchange information (e.g., using 3G-ANR procedures or any other suitable procedures).

Macrocell base stations in different frequencies are sometimes co-located (i.e., located at substantially the same physical location). To accommodate co-located macrocells, the present methods may be adapted as follows. If co-located macrocells operating in different frequencies have same PSCs, then the NCL_(PSC,interfreq) may contain PSCs in the NCL_(PSC,intrafreq). This is because detected cells can be reported for intra-frequency cells. If co-located macrocell information is available at the HNB, then the PSCs provided in the temporary NCL (e.g., intra and inter NCL) to the UE may be obtained from intra-frequency detected cell MRMs.

### Management of NCL

The NCL may be managed at the femtocell or another entity (e.g., at the operator core network). For example, a preferred PSC list may be constructed at the femtocell that can be used for mobility management procedures.

The disclosure relates in some aspects to ranking PSCs (or creating a preferred PSC set) within the NCL, for both intra-frequency cells and inter-frequency cells. For example, PSCs in the NCL may be ranked to indicate an order of preference of neighbor cells for use in mobile entity mobility management. Lower-ranked PSCs may be removed from the list to maintain the NCL within a defined membership threshold. Thus, the NCL will contain only the highest ranked PSCs. Moreover, through the use of prioritization as taught herein, the NCL may be populated in a manner reduces the amount of time it takes for an access terminal to detect nearby cells.

Prioritization of an NCL may include using one of the methods described herein to create a potential list of NCL PSCs. The femtocell then provisions intra-frequency and inter-frequency reporting (periodic or event based) for the PSCs obtained. Next, the femtocell creates a score for the PSCs based on, for example, one or more of: (a) path loss (PL), CPICH Ec/Io, or CPICH RSCP; (b) idle registrations; (c) information from events generated during handovers (e.g., event 2d, event 2b, event 1a, etc); (d) the frequency with which a PSC (or, in general, a neighbor cell) is observed in MRMs; (e) configured, or otherwise acquired (from HMS, neighbor broadcasts, etc) information on barring state of neighbors; or (f) reselection and/or handover parameters acquired. Advantageously, these techniques may be compatible with legacy UEs.

Thus, in some aspects, a prioritization method may include scoring the PSCs based on a signal quality indicator for respective associated neighbor cells. In the alternative, or in addition, prioritizing the PSCs may include scoring the PSCs based on registrations of idle mobile entities. For example, a score may be assigned in proportion to a cumulative count of registrations. In the alternative, or in addition, prioritizing the PSCs may include scoring the PSCs based on information from events generated during handovers to neighbor cells. Such handover events may indicate activity of a neighbor cell, relative to a given cell, and thus may be useful for scoring. In the alternative, or in addition, prioritizing the PSCs may include scoring the PSCs based on how frequently each PSC is reported in Measurement Report Messages (MRMs) received from one or more mobile entities in a coverage area of the cell. The various alternatives may be selected based on what information is readily available at the time the scoring is performed.

In one embodiment, based on the received MRMs from the SRNC, the HNB may identify the strongest PSC, in terms of power level (PL), Receive Signal Code Power (RSCP), and energy of carrier over all noise (Ec/Io), at time of hand-in. In addition, from repeated active hand-ins, the HNB may rank cells based on how frequently PSCs are reported in the MRMs. Also, the HNB may provision intra and inter frequency reporting (periodic or event based) for the PSCs obtained from the SRNC, as described above.

In some embodiments, NCL management methods involve limiting the size of the NCL. For example, the length of the candidate PSC set may be limited (e.g., some current standards restrict the size of an NCL to 32 or less). Thus, if an initially created PSC set is larger than the designated size (e.g., greater than 32 PSCs), the list is pruned.

The disclosure relates in some aspects to creating a temporary NCL with determined PSCs for transmitting to a mobile entity (e.g., a UE). This may include determining the PSCs for the temporary NCL so as to provide different versions of the temporary NCL, each comprising a different subset of PSCs smaller than a defined set of all available PSCs (i.e., the subset reference above); for example, cycling through 512 possible PSCs in subsets of 32 PSCs at a time. The method may further include transmitting the different versions of the temporary NCL to the mobile entity at respective different times to provoke detection by the mobile entity of all detectable neighbor cells using any one of the defined set of all available PSCs on a wireless frequency not used by the mobile entity for communication with the serving cell. In other words, transmitting the different NCL versions may be performed to enable the mobile station to detect inter-frequency cells. It should also be appreciated that such a scheme may be employed for intra-frequency measurements in some embodiments.

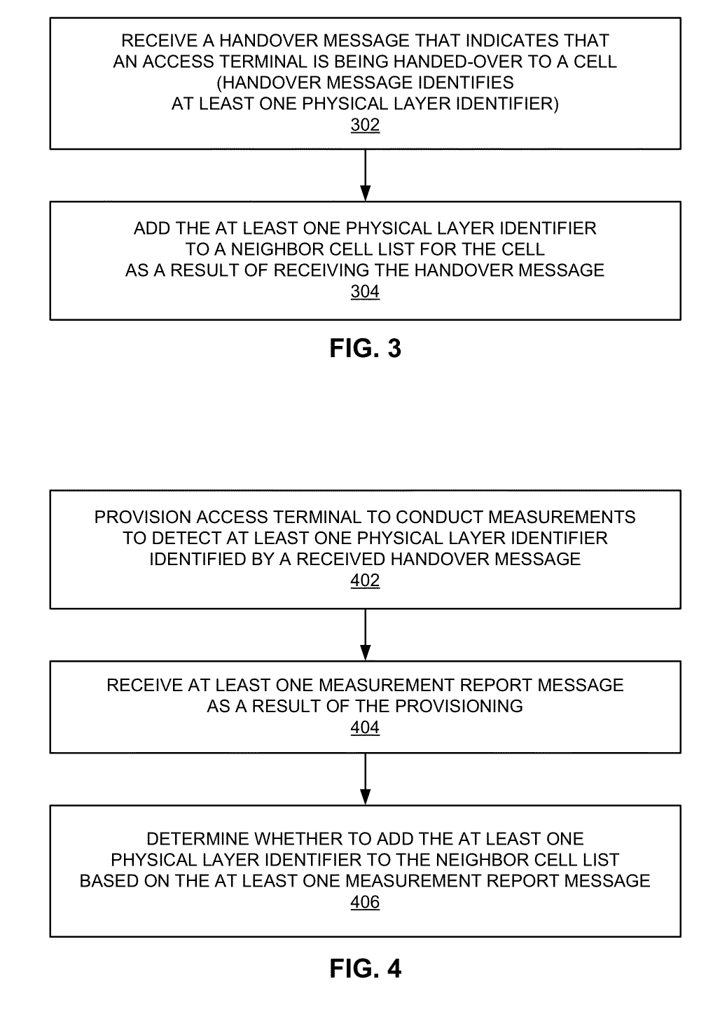

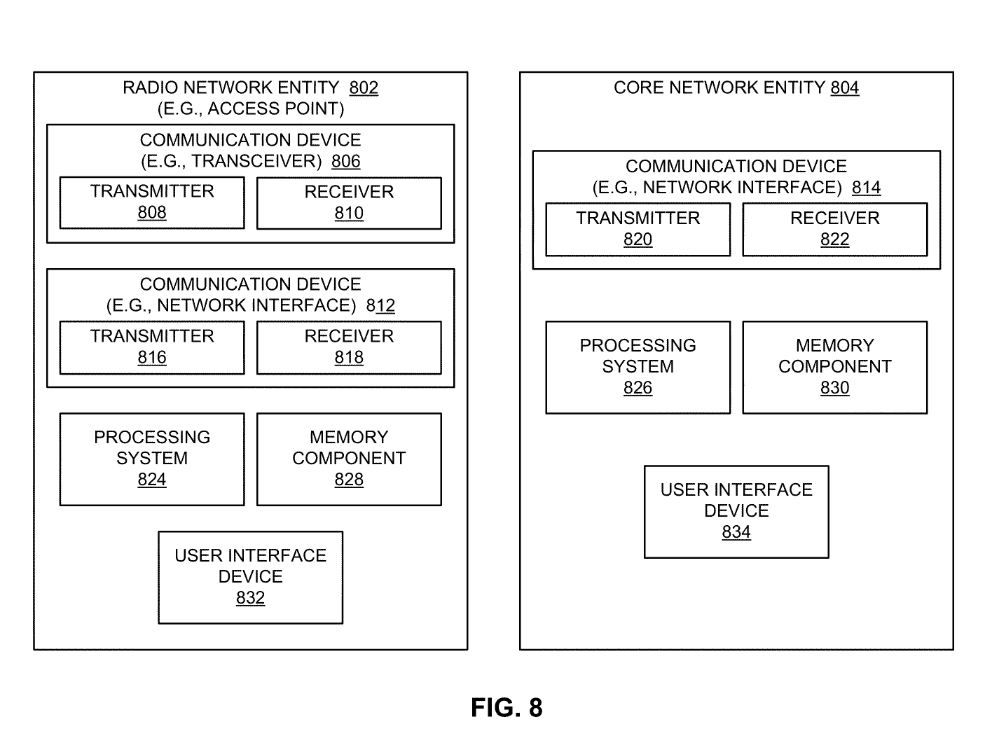

Additional details relating to maintaining (e.g., creating, defining, managing, etc.) an NCL will now be described in conjunction with the flowcharts of FIGS. 3-7. For convenience, the operations of FIGS. 3-7 (or any other operations discussed or taught herein) may be described as being performed by specific components (e.g., components of FIG. 1 or 8). For example, in some embodiments, most of the operations of FIGS. 3-7 may be performed by a femtocell for which the NCL is being maintained. In other embodiments, however, many of the operations of FIGS. 3-7 may be performed by a network entity that maintains the NCL for the femtocell and sends the updated NCL to the femtocell. It should be appreciated, however, that these operations may be performed by other types of components and may be performed using a different number of components. It also should be appreciated that one or more of the operations described herein may not be employed in a given implementation.

For purposes of illustration, the following discussion may refer to physical layer identifiers of a cell of an access point. It should be appreciated that a given access point may comprise a single physical cell or multiple physical cells. Also, depending on the context, in some cases the term cell refers to a coverage area of a physical cell.

FIG. 3 describes several high-level operations that may be performed in conjunction with maintaining an NCL for a cell. The operations may be performed by the cell (e.g., a femtocell), by a network entity that sends the maintained NCL to the cell (e.g., periodically, whenever, the NCL is updated, and so on), or some other suitable entity.

As represented by block 302, a handover message that indicates that an access terminal is being handed-over to a cell is received (e.g., at the cell or at a network entity). This handover message identifies at least one physical layer identifier (e.g., primary scrambling code). In various embodiments, the handover message comprises, for example, a Relocation Request message, an Enhanced Relocation Information Request message, a Relocation Required message, or a Handover Request message.

In some cases, the handover message includes at least one measurement report message generated by the access terminal. Here, the at least one physical layer identifier is indicated by the at least one measurement report message.

In some cases, the handover message includes at least one neighbor cell list associated with the access terminal. The at least one physical layer identifier is indicated by the at least one neighbor cell list in these cases. In addition, the at least one neighbor cell list may be received from a network entity that initiated the handover of the terminal.

As represented by block 304, the at least one physical layer identifier is added to a neighbor cell list for the cell as a result of receiving the handover message.

FIG. 4 describes several operations for provisioning an access terminal to conduct measurements of the physical layer identifiers identified by a handover message. In this way, it may be verified as to whether the corresponding cells are currently detectable. These operations are generally performed by the serving cell for the access terminal (e.g., by a femtocell or an SRNC).

As represented by block 402, an access terminal is provisioned to conduct measurements to detect at least one physical layer identifier identified by a handover message. For example, in some cases, the cell sends measurement control messages that instruct the access terminal to conduct measurements and send back measurement report messages. In some cases, the cell send a message indicating that Detected Set reporting is enabled.

As represented by block 404, at least one measurement report message is received from the access terminal as a result of the provisioning. As discussed above, the measurement report messages may include intra-frequency, inter-frequency, and inter-RAT physical layer identifiers.

As represented by block 406, a determination is then made, based on the at least one measurement report message, whether to add the physical layer identifier(s) to the neighbor cell list. For example, a physical layer identifier may be added if its associated received signal quality (e.g., signal strength) exceeds a threshold.

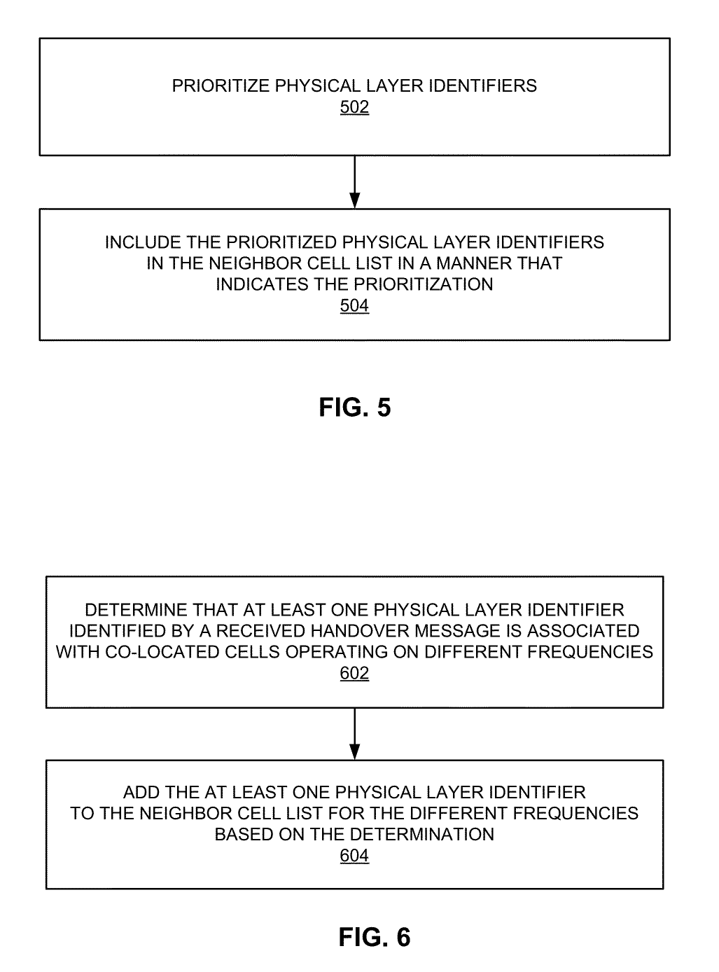

FIG. 5 describes several operations for prioritizing physical layer identifiers for an NCL. The operations may be performed by the cell, by a network entity, or some other suitable entity.

As represented by block 502, physical layer identifiers (e.g., a defined set of physical layer identifiers) for an NCL are prioritized. For example, as discussed herein, prioritization may be employed to determine which physical layer identifiers are to be included in the NCL and/or the physical layer identifiers of the NCL may be prioritized.

As represented by block 504, the physical layer identifiers are included in the NCL in a manner that indicates the prioritization. For example, the physical layer identifiers may be placed in the NCL in a defined order, or an indication of the order may be provided along with the NCL. In some embodiments, the prioritization is based on whether a physical layer identifier of the set is received in a measurement report message generated by the access terminal or in a neighbor cell list associated with the access terminal.

In some embodiments, the prioritization of the physical layer identifiers of the NCL is based on at least one of: signal quality information associated with the at least one physical layer identifier during the handover, path loss information associated with the at least one physical layer identifier during the handover, registrations of idle access terminals at cells associated with the at least one physical layer identifier, information from events generated during the handover, how frequently the at least one physical layer identifier is reported in measurement report messages, or whether the at least one physical layer identifier is associated with a cell providing closed or hybrid access.

FIG. 6 describes several operations relating to maintaining an NCL based on co-located cell information. The operations may be performed by the cell, by a network entity, or some other suitable entity.

As represented by block 602, a determination is made as to whether at least one physical layer identifier identified by a handover message is associated with co-located cells operating on different frequencies. As represented by block 604, based on the determination of block 602, the physical layer identifier(s) may be added to the neighbor cell list for the different frequencies. For example, if a physical layer identifier of co-located cell for a first frequency has been detected (e.g., is currently in the NCL), the corresponding physical layer identifier (i.e., the same identifier) of the co-located cell for a second frequency is added to the NCL.

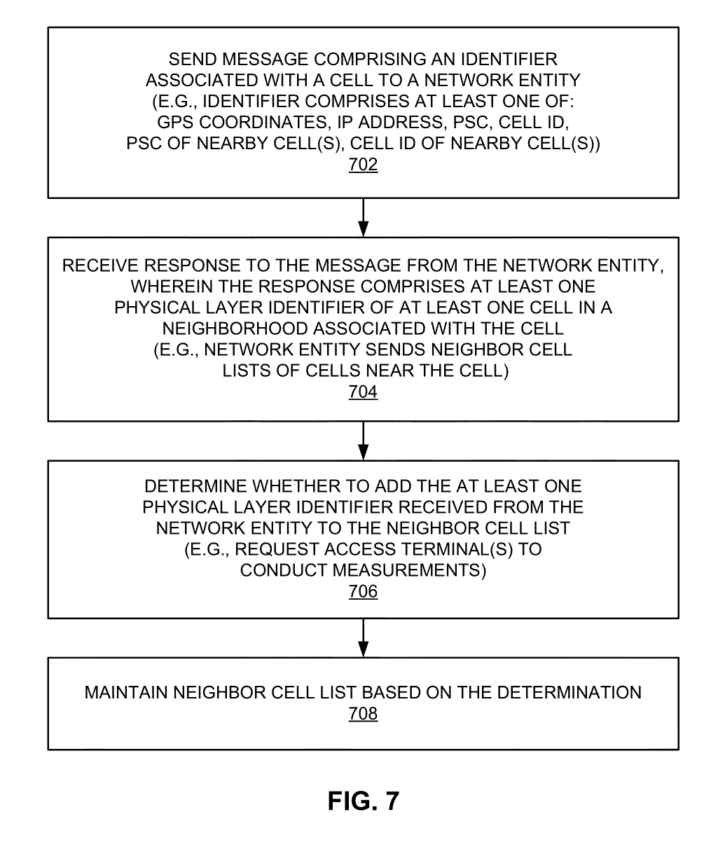

FIG. 7 describes several operations relating to maintaining an NCL based on information from a network entity. These operations are typically performed by the cell (e.g., by a femtocell or an SRNC).

As represented by block 702, a message comprising an identifier associated with the cell is sent to a network entity. This identifier may take different forms in different embodiments. For example, the identifier may comprise at least one of: GPS coordinates of the cell, the IP address of the cell, the physical layer identifier (e.g., PSC) of the cell, the cell ID of the cell, the physical layer identifiers (e.g., PSCs) of nearby cell(s), or the cell IDs of nearby cell(s).

Upon receiving this message, the network entity will identify any cells that are in a neighborhood associated with the cell. The network entity will then send a message (e.g., to the cell) including the physical layer identifiers (and optionally other information such as cell IDs) associated with the identified cells. For example, the network entity may send the physical layer identifiers of these cells and, in some cases, the NCLs of these cells.

Accordingly, as represented by block 704, a response to the message of block 902 is received from the network entity. As discussed above, the response may comprise at least one physical layer identifier of at least one cell in a neighborhood associated with the cell.

As represented by block 706, a determination is then made, based on the response, whether to add the physical layer identifier(s) received from the network entity to the NCL. Accordingly, as represented by block 708, the NCL for the cell may be maintained based on the determination of block 706.

FIG. 8 illustrates several sample components (represented by corresponding blocks) that may be incorporated into nodes such as a radio network entity (e.g., hereafter referred to as the access point 802) and a core network entity 804 (e.g., corresponding to the access point 106 and the network entity 114 of FIG. 1, respectively) to perform NCL-related operations as taught herein. The described components also may be incorporated into other nodes in a communication system. For example, other nodes in a system may include components similar to those described for the access point 802 to provide similar functionality. Also, a given node may contain one or more of the described components. For example, an access point may contain multiple transceiver components that enable the access point to operate on multiple carriers and/or communicate via different technologies.

As shown in FIG. 8, the access point 802 includes one or more wireless communication devices 806 (e.g., a transceiver) for communicating with other nodes (e.g., access terminals.) Each communication device 806 includes a transmitter 808 for sending signals (e.g., messages, information) and a receiver 810 for receiving signals (e.g., messages, information). In some embodiments, a communication device 806 (e.g., one of multiple wireless communication devices of the access point 802) comprises a network listen module.

The access point 802 and the network entity 804 also include one or more communication devices 812 and 814 (e.g., a network interface), respectively, for communicating with other nodes (e.g., network entities). For example, a communication device 812 or 814 may be configured to communicate with one or more network entities via a wire-based or wireless backhaul. In some aspects, a communication device 812 or 814 may be implemented as a transceiver (e.g., including transmitter and receiver components) configured to support wire-based or wireless signal communication. This communication may involve, for example, sending and receiving: messages, parameters, other types of information, and so on. Accordingly, in the example of FIG. 8, the communication device 812 is shown as including a transmitter 816 and a receiver 818, while the communication device 814 is shown as including a transmitter 820 and a receiver 822.

The access point 802 and the network entity 804 also include other components that may be used in conjunction with NCL-related operations as taught herein. For example, the access point 802 includes a processing system 824 for providing functionality relating to maintaining an NCL and for providing other processing functionality. Similarly, the network entity 804 includes a processing system 826 for providing functionality relating to maintaining an NCL and for providing other processing functionality. The access point 802 and the network entity 804 each include a memory component 828 and 830 (e.g., including a memory device), respectively, for maintaining information (e.g., traffic information, thresholds, parameters, and so on). In addition, the access point 802 and the network entity 804 each include a user interface device 832 and 834, respectively, for providing indications (e.g., audible and/or visual indications) to a user and/or for receiving user input (e.g., upon user actuation of a sensing device such a keypad, a touch screen, a microphone, and so on).

For convenience the access point 802 and the network entity 804 are shown in FIG. 8 as including components that may be used in the various examples described herein. In practice, the illustrated blocks may have different functionality in different implementations. For example, in some implementations the functionality of the block 824 may be different in an embodiment implemented in accordance with FIG. 6 as compared to an embodiment implemented in accordance with FIG. 7.

The components of FIG. 8 may be implemented in various ways. In some implementations the components of FIG. 8 may be implemented in one or more circuits such as, for example, one or more processors and/or one or more ASICs (which may include one or more processors). Here, each circuit (e.g., processor) may use and/or incorporate data memory for storing information or executable code used by the circuit to provide this functionality. For example, some of the functionality represented by blocks 806 and 812, and some or all of the functionality represented by blocks 824, 828, and 832 may be implemented by a processor or processors of an access point and data memory of the access point (e.g., by execution of appropriate code and/or by appropriate configuration of processor components). Similarly, some of the functionality represented by block 814, and some or all of the functionality represented by blocks 826, 830, and 834 may be implemented by a processor or processors of a network entity and data memory of the network entity (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macrocell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macrocell, and so on. Also, a femto access point may be configured or referred to as a Home NodeB, Home eNodeB, access point base station, femtocell, and so on. In some implementations, a node may be associated with (e.g., referred to as or divided into) one or more cells or sectors. A cell or sector associated with a macro access point, a femto access point, or a pico access point may be referred to as a macrocell, a femtocell, or a picocell, respectively.

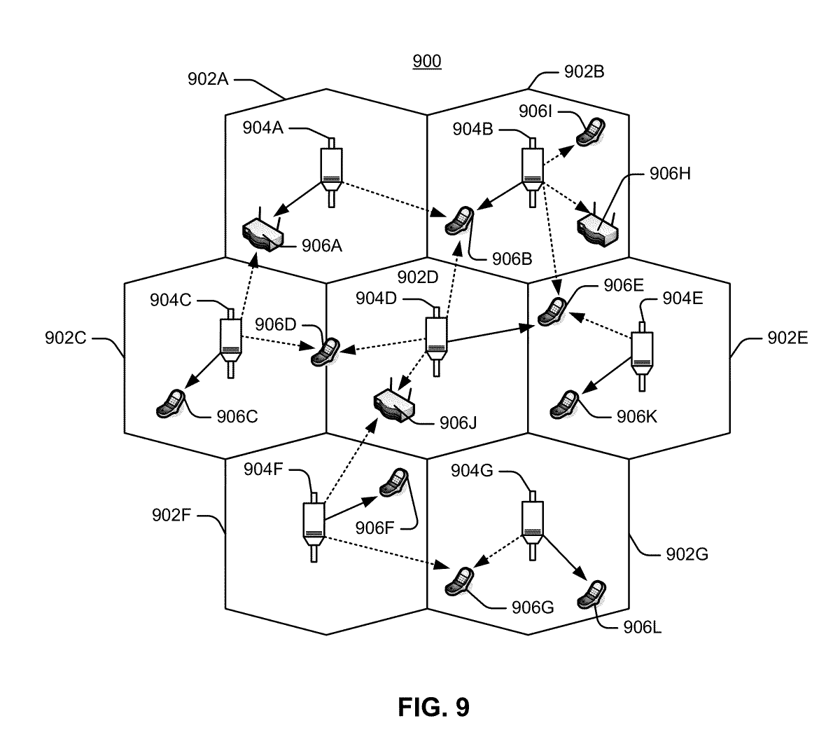

FIG. 9 illustrates a wireless communication system 900, configured to support a number of users, in which the teachings herein may be implemented. The system 900 provides communication for multiple cells 902, such as, for example, macrocells 902A-902G, with each cell being serviced by a corresponding access point 904 (e.g., access points 904A-904G). As shown in FIG. 9, access terminals 906 (e.g., access terminals 906A-906L) may be dispersed at various locations throughout the system over time. Each access terminal 906 may communicate with one or more access points 904 on a forward link (FL) and/or a reverse link (RL) at a given moment, depending upon whether the access terminal 906 is active and whether it is in soft handoff, for example. The wireless communication system 900 may provide service over a large geographic region. For example, macrocells 902A-902G may cover a few blocks in a neighborhood or several miles in a rural environment.

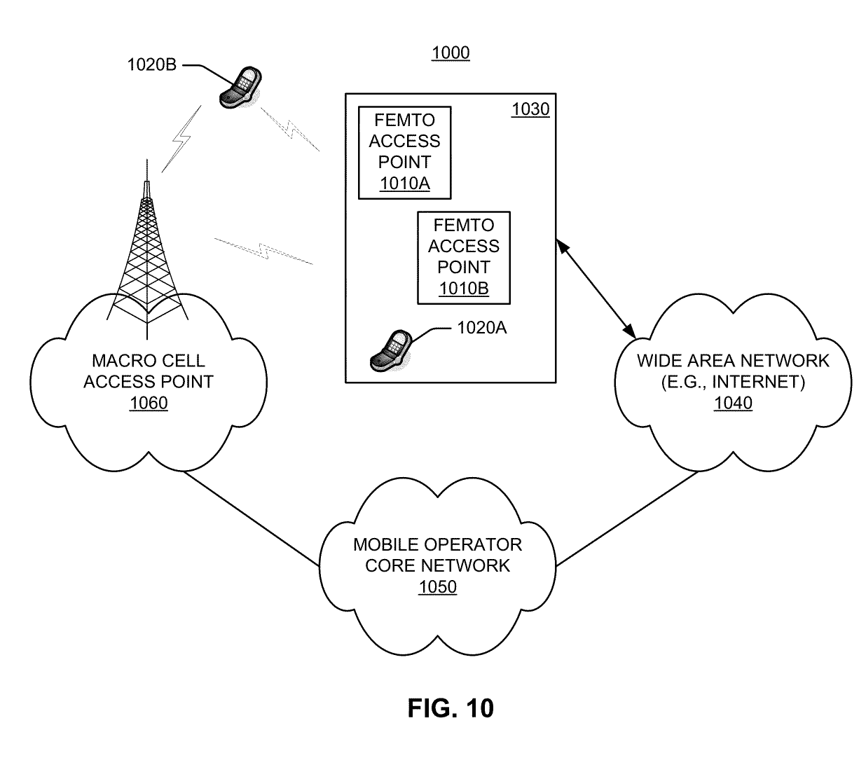

FIG. 10 illustrates an exemplary communication system 1000 where one or more femto access points are deployed within a network environment. Specifically, the system 1000 includes multiple femto access points 1010 (e.g., femto access points 1010A and 1010B) installed in a relatively small scale network environment (e.g., in one or more user residences 1030). Each femto access point 1010 may be coupled to a wide area network 1040 (e.g., the Internet) and a mobile operator core network 1050 via a DSL router, a cable modem, a wireless link, or other connectivity means (not shown). As will be discussed below, each femto access point 1010 may be configured to serve associated access terminals 1020 (e.g., access terminal 1020A) and, optionally, other (e.g., hybrid or alien) access terminals 1020 (e.g., access terminal 1020B). In other words, access to femto access points 1010 may be restricted whereby a given access terminal 1020 may be served by a set of designated (e.g., home) femto access point(s) 1010 but may not be served by any non-designated femto access points 1010 (e.g., a neighbor's femto access point 1010).

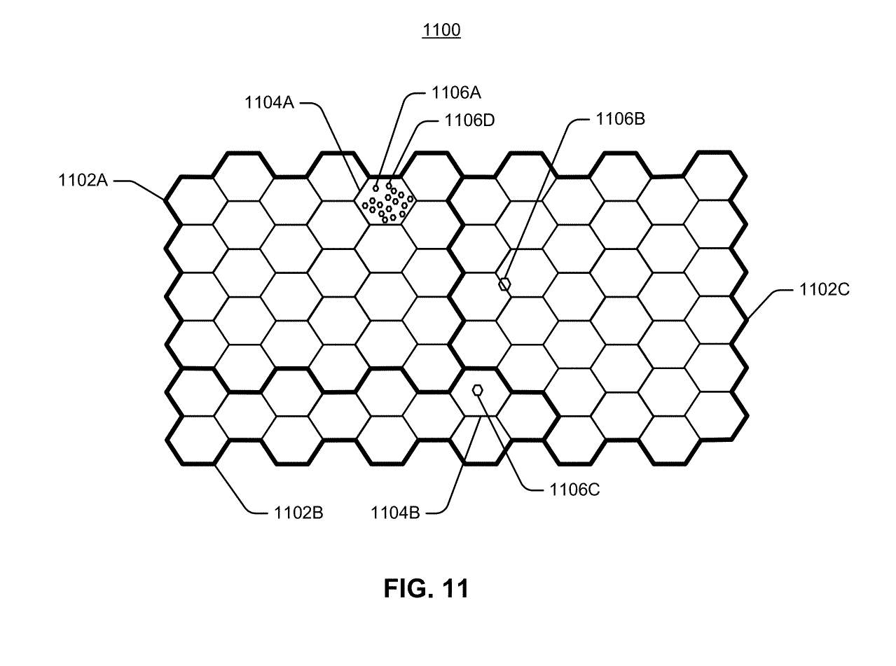

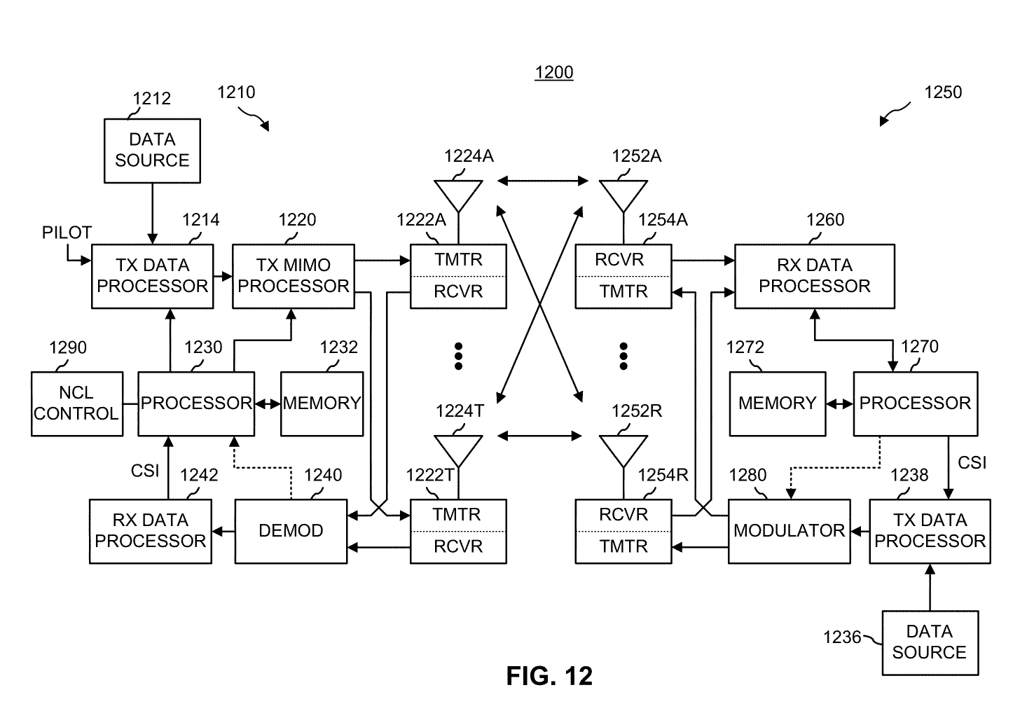

FIG. 11 illustrates an example of a coverage map 1100 where several tracking areas 1102 (or routing areas or location areas) are defined, each of which includes several macro coverage areas 1104. Here, areas of coverage associated with tracking areas 1102A, 1102B, and 1102C are delineated by the wide lines and the macro coverage areas 1104 are represented by the larger hexagons. The tracking areas 1102 also include femto coverage areas 1106. In this example, each of the femto coverage areas 1106 (e.g., femto coverage areas 1106B and 1106C) is depicted within one or more macro coverage areas 1104 (e.g., macro coverage areas 1104A and 1104B). It should be appreciated, however, that some or all of a femto coverage area 1106 may not lie within a macro coverage area 1104. In practice, a large number of femto coverage areas 1106 (e.g., femto coverage areas 1106A and 1106D) may be defined within a given tracking area 1102 or macro coverage area 1104. Also, one or more pico coverage areas (not shown) may be defined within a given tracking area 1102 or macro coverage area 1104.

Referring again to FIG. 10, the owner of a femto access point 1010 may subscribe to mobile service, such as, for example, 3G mobile service, offered through the mobile operator core network 1050. In addition, an access terminal 1020 may be capable of operating both in macro environments and in smaller scale (e.g., residential) network environments. In other words, depending on the current location of the access terminal 1020, the access terminal 1020 may be served by a macrocell access point 1060 associated with the mobile operator core network 1050 or by any one of a set of femto access points 1010 (e.g., the femto access points 1010A and 1010B that reside within a corresponding user residence 1030). For example, when a subscriber is outside his home, he is served by a standard macro access point (e.g., access point 1060) and when the subscriber is at home, he is served by a femto access point (e.g., access point 1010A). Here, a femto access point 1010 may be backward compatible with legacy access terminals 1020.

A femto access point 1010 may be deployed on a single frequency or, in the alternative, on multiple frequencies. Depending on the particular configuration, the single frequency or one or more of the multiple frequencies may overlap with one or more frequencies used by a macro access point (e.g., access point 1060).

In some aspects, an access terminal 1020 may be configured to connect to a preferred femto access point (e.g., the home femto access point of the access terminal 1020) whenever such connectivity is possible. For example, whenever the access terminal 1020A is within the user's residence 1030, it may be desired that the access terminal 1020A communicate only with the home femto access point 1010A or 1010B.

In some aspects, if the access terminal 1020 operates within the macro cellular network 1050 but is not residing on its most preferred network (e.g., as defined in a preferred roaming list), the access terminal 1020 may continue to search for the most preferred network (e.g., the preferred femto access point 1010) using a better system reselection (BSR) procedure, which may involve a periodic scanning of available systems to determine whether better systems are currently available and subsequently acquire such preferred systems. The access terminal 1020 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 1010, the access terminal 1020 selects the femto access point 1010 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macrocell mobile network and a defined set of femto access points (e.g., the femto access points 1010 that reside within the corresponding user residence 1030). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

FIG. 12 illustrates a wireless device 1210 (e.g., an access point) and a wireless device 1250 (e.g., an access terminal) of a sample MIMO system 1200. At the device 1210, traffic data for a number of data streams is provided from a data source 1212 to a transmit (TX) data processor 1214. Each data stream may then be transmitted over a respective transmit antenna.

The TX data processor 1214 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1230. A data memory 1232 may store program code, data, and other information used by the processor 1230 or other components of the device 1210.

The modulation symbols for all data streams are then provided to a TX MIMO processor 1220, which may further process the modulation symbols (e.g., for OFDM). The TX MIMO processor 1220 then provides N_{T} modulation symbol streams to N_{T} transceivers (XCVR) 1222A through 1222T. In some aspects, the TX MIMO processor 1220 applies beam-forming weights to the symbols of the data streams and to the antenna from which the symbol is being transmitted.

Each transceiver 1222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1222A through 1222T are then transmitted from N_{T} antennas 1224A through 1224T, respectively.

At the device 1250, the transmitted modulated signals are received by N_{R} antennas 1252A through 1252R and the received signal from each antenna 1252 is provided to a respective transceiver (XCVR) 1254A through 1254R. Each transceiver 1254 conditions (e.g., filters, amplifies, and downconverts) a respective received signal, digitizes the conditioned signal to provide samples, and further processes the samples to provide a corresponding “received” symbol stream.

A receive (RX) data processor 1260 then receives and processes the N_{R} received symbol streams from N_{R} transceivers 1254 based on a particular receiver processing technique to provide N_{T} “detected” symbol streams. The RX data processor 1260 then demodulates, deinterleaves, and decodes each detected symbol stream to recover the traffic data for the data stream. The processing by the RX data processor 1260 is complementary to that performed by the TX MIMO processor 1220 and the TX data processor 1214 at the device 1210.

A processor 1270 periodically determines which pre-coding matrix to use (discussed below). The processor 1270 formulates a reverse link message comprising a matrix index portion and a rank value portion. A data memory 1272 may store program code, data, and other information used by the processor 1270 or other components of the device 1250.

The reverse link message may comprise various types of information regarding the communication link and/or the received data stream. The reverse link message is then processed by a TX data processor 1238, which also receives traffic data for a number of data streams from a data source 1236, modulated by a modulator 1280, conditioned by the transceivers 1254A through 1254R, and transmitted back to the device 1210.

At the device 1210, the modulated signals from the device 1250 are received by the antennas 1224, conditioned by the transceivers 1222, demodulated by a demodulator (DEMOD) 1240, and processed by a RX data processor 1242 to extract the reverse link message transmitted by the device 1250. The processor 1230 then determines which pre-coding matrix to use for determining the beam-forming weights then processes the extracted message.

FIG. 12 also illustrates that the communication components may include one or more components that perform NCL control operations as taught herein. For example, an NCL control component 1290 may cooperate with the processor 1230 and/or other components of the device 1210 to maintain an NCL as taught herein. It should be appreciated that for each device 1210 and 1250 the functionality of two or more of the described components may be provided by a single component. For example, a single processing component may provide the functionality of the NCL control component 1290 and the processor 1230.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1xRTT, 1xEV-DO Re10, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macrocell, a macro node, a Home eNB (HeNB), a femtocell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

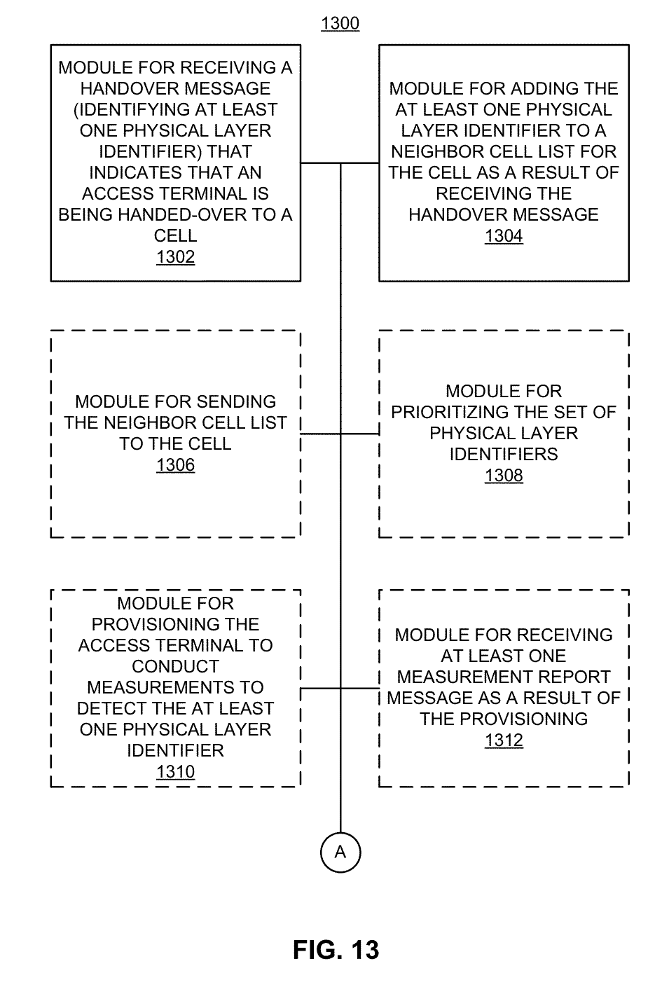

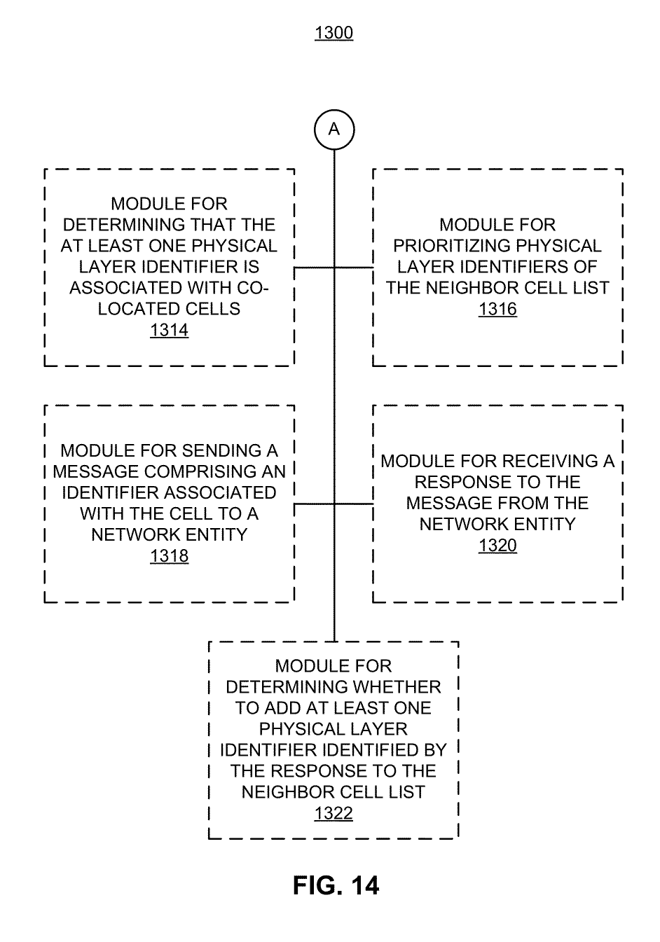

The functionality described herein (e.g., with regard to one or more of the accompanying figures) may correspond in some aspects to similarly designated “means for” functionality in the appended claims. Referring to FIGS. 13 and 14, an apparatus 1300 is represented as a series of interrelated functional modules. Here, a module for receiving a handover message (indentifying at least one physical layer) that indicates that an access terminal is being handed-over to a cell 1302 may correspond at least in some aspects to, for example, a communication device as discussed herein. A module for adding the at least one physical layer identifier to a neighbor cell list for the cell as a result of receiving the handover message 1304 may correspond at least in some aspects to, for example, a processing system as discussed herein. A module for sending the neighbor cell list to the cell 1306 may correspond at least in some aspects to, for example, a communication device as discussed herein. A module for prioritizing the set of physical layer identifiers 1308 may correspond at least in some aspects to, for example, a processing system as discussed herein. A module for provisioning the access terminal to conduct measurements to detect the at least one physical layer identifier 1310 may correspond at least in some aspects to, for example, a processing system as discussed herein. A module for receiving at least one measurement report message as a result of the provisioning 1312 may correspond at least in some aspects to, for example, a communication device as discussed herein. A module for determining that the at least one physical layer identifier is associated with co-located cells 1314 may correspond at least in some aspects to, for example, a processing system as discussed herein. A module for prioritizing physical layer identifiers of the neighbor cell list 1316 may correspond at least in some aspects to, for example, a processing system as discussed herein. A module for sending a message comprising an identifier associated with the cell to a network entity 1318 may correspond at least in some aspects to, for example, a communication device as discussed herein. A module for receiving a response to the message from the network entity 1320 may correspond at least in some aspects to, for example, a communication device as discussed herein. A module for determining whether to add at least one physical layer identifier identified by the response to the neighbor cell list 1322 may correspond at least in some aspects to, for example, a processing system as discussed herein.

The functionality of the modules of FIGS. 13 and 14 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIGS. 13 and 14 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a communication device configured to receive a handover message that indicates that an access terminal is being handed-over to a cell, wherein the handover message identifies at least one physical layer identifier; and
a processing system configured to add the at least one physical layer identifier to a neighbor cell list for the cell as a result of receiving the handover message.

2. The apparatus of claim 1, wherein:
the handover message includes at least one measurement report message generated by the access terminal; and
the at least one physical layer identifier is indicated by the at least one measurement report message.

3. The apparatus of claim 1, wherein:
the handover message includes at least one neighbor cell list associated with the access terminal; and
the at least one physical layer identifier is indicated by the at least one neighbor cell list associated with the access terminal.

4. The apparatus of claim 3, wherein the at least one neighbor cell list associated with the access terminal is received from a network entity that initiated the handover of the terminal.

5. The apparatus of claim 1, wherein the handover message comprises a Relocation Request message, an Enhanced Relocation Information Request message, a Relocation Required message, or a Handover Request message.

6. The apparatus of claim 1, wherein the at least one physical layer identifier comprises at least one primary scrambling code.

7. The apparatus of claim 1, wherein the apparatus comprises the cell.

8. The apparatus of claim 7, wherein the apparatus is a femtocell.

9. The apparatus of claim 1, wherein:
the apparatus is a network entity; and
the apparatus further comprising another communication device configured to send the neighbor cell list to the cell.

10. The apparatus of claim 1, wherein:
the processing system is further configured to provision the access terminal to conduct measurements to detect the at least one physical layer identifier;
the apparatus further comprises another communication device configured to receive at least one measurement report message as a result of the provisioning; and
the adding of the at least one physical layer identifier to the neighbor cell list comprises determining to add the at least one physical layer identifier to the neighbor cell list based on the at least one measurement report message.

11. The apparatus of claim 1, wherein:
the processing system is further configured to determine that the at least one physical layer identifier is associated with co-located cells operating on different frequencies; and
the at least one physical layer identifier is added to the neighbor cell list for the different frequencies based on the determination.

12. The apparatus of claim 1, wherein:
the at least one physical layer identifier comprises a set of physical layer identifiers;
the processing system is further configured to prioritize the set of physical layer identifiers; and
the adding of the at least one physical layer identifier to the neighbor cell list comprises including the prioritized set of physical layer identifiers in the neighbor cell list in a manner that indicates the prioritization.

13. The apparatus of claim 12, wherein the prioritization is based on whether a physical layer identifier of the set is received in a measurement report message generated by the access terminal or in a neighbor cell list associated with the access terminal.

14. The apparatus of claim 1, wherein the processing system is further configured to prioritize physical layer identifiers of the neighbor cell list based on at least one of: signal quality information associated with the at least one physical layer identifier during the handover, path loss information associated with the at least one physical layer identifier during the handover, registrations of idle access terminals at cells associated with the at least one physical layer identifier, information from events generated during the handover, how frequently the at least one physical layer identifier is reported in measurement report messages, or whether the at least one physical layer identifier is associated with a cell providing closed or hybrid access.

15. The apparatus of claim 1, wherein:
the communication device is further configured to send a message comprising an identifier associated with the cell to a network entity and to receive a response to the message from the network entity;
the response identifies at least one physical layer identifier of at least one cell in a neighborhood associated with the cell; and
the processing system is further configured to determine whether to add the at least one physical layer identifier identified by the response to the neighbor cell list.

16. A method of communication, comprising:
receiving a handover message that indicates that an access terminal is being handed-over to a cell, wherein the handover message identifies at least one physical layer identifier; and
adding the at least one physical layer identifier to a neighbor cell list for the cell as a result of receiving the handover message.

17. The method of claim 16, wherein:
the handover message includes at least one measurement report message generated by the access terminal; and
the at least one physical layer identifier is indicated by the at least one measurement report message.

18. The method of claim 16, wherein:
the handover message includes at least one neighbor cell list associated with the access terminal; and
the at least one physical layer identifier is indicated by the at least one neighbor cell list associated with the access terminal.

19. The method of claim 18, wherein the at least one neighbor cell list associated with the access terminal is received from a network entity that initiated the handover of the terminal.

20. The method of claim 16, wherein the handover message comprises a Relocation Request message, an Enhanced Relocation Information Request message, a Relocation Required message, or a Handover Request message.

21. The method of claim 16, wherein the at least one physical layer identifier comprises at least one primary scrambling code.

22. The method of claim 16, wherein the method is performed by the cell.

23. The method of claim 22, wherein the cell comprises a femtocell.

24. The method of claim 16, wherein the method is performed by a network entity, the method further comprising sending the neighbor cell list to the cell.

25. The method of claim 16, further comprising:
provisioning the access terminal to conduct measurements to detect the at least one physical layer identifier; and
receiving at least one measurement report message as a result of the provisioning, wherein the adding of the at least one physical layer identifier to the neighbor cell list comprises determining to add the at least one physical layer identifier to the neighbor cell list based on the at least one measurement report message.

26. The method of claim 16, further comprising determining that the at least one physical layer identifier is associated with co-located cells operating on different frequencies, wherein the at least one physical layer identifier is added to the neighbor cell list for the different frequencies based on the determination.

27. The method of claim 16, wherein:
the at least one physical layer identifier comprises a set of physical layer identifiers;
the method further comprises prioritizing the set of physical layer identifiers; and
the adding of the at least one physical layer identifier to the neighbor cell list comprises including the prioritized set of physical layer identifiers in the neighbor cell list in a manner that indicates the prioritization.

28. The method of claim 27, wherein the prioritization is based on whether a physical layer identifier of the set is received in a measurement report message generated by the access terminal or in a neighbor cell list associated with the access terminal.

29. The method of claim 16, further comprising prioritizing physical layer identifiers of the neighbor cell list based on at least one of: signal quality information associated with the at least one physical layer identifier during the handover, path loss information associated with the at least one physical layer identifier during the handover, registrations of idle access terminals at cells associated with the at least one physical layer identifier, information from events generated during the handover, how frequently the at least one physical layer identifier is reported in measurement report messages, or whether the at least one physical layer identifier is associated with a cell providing closed or hybrid access.

30. The method of claim 16, further comprising:
sending a message comprising an identifier associated with the cell to a network entity;
receiving a response to the message from the network entity, wherein the response identifies at least one physical layer identifier of at least one cell in a neighborhood associated with the cell; and
determining whether to add the at least one physical layer identifier identified by the response to the neighbor cell list.

31. An apparatus for communication, comprising:
means for receiving a handover message that indicates that an access terminal is being handed-over to a cell, wherein the handover message identifies at least one physical layer identifier; and
means for adding the at least one physical layer identifier to a neighbor cell list for the cell as a result of receiving the handover message.

32. The apparatus of claim 31, wherein the apparatus comprises the cell.

33. The apparatus of claim 31, wherein:
the apparatus is a network entity; and
the apparatus further comprises means for sending the neighbor cell list to the cell.

34. The apparatus of claim 31, further comprising:
means for provisioning the access terminal to conduct measurements to detect the at least one physical layer identifier; and
means for receiving at least one measurement report message as a result of the provisioning, wherein the adding of the at least one physical layer identifier to the neighbor cell list comprises determining to add the at least one physical layer identifier to the neighbor cell list based on the at least one measurement report message.

35. The apparatus of claim 31, further comprising means for determining that the at least one physical layer identifier is associated with co-located cells operating on different frequencies, wherein the at least one physical layer identifier is added to the neighbor cell list for the different frequencies based on the determination.

36. The apparatus of claim 31, wherein:
the at least one physical layer identifier comprises a set of physical layer identifiers;
the apparatus further comprises means for prioritizing the set of physical layer identifiers; and
the adding of the at least one physical layer identifier to the neighbor cell list comprises including the prioritized set of physical layer identifiers in the neighbor cell list in a manner that indicates the prioritization.

37. The apparatus of claim 31, further comprising means for prioritizing physical layer identifiers of the neighbor cell list based on at least one of: signal quality information associated with the at least one physical layer identifier during the handover, path loss information associated with the at least one physical layer identifier during the handover, registrations of idle access terminals at cells associated with the at least one physical layer identifier, information from events generated during the handover, how frequently the at least one physical layer identifier is reported in measurement report messages, or whether the at least one physical layer identifier is associated with a cell providing closed or hybrid access.

38. The apparatus of claim 31, further comprising:
means for sending a message comprising an identifier associated with the cell to a network entity;
means for receiving a response to the message from the network entity, wherein the response identifies at least one physical layer identifier of at least one cell in a neighborhood associated with the cell; and
means for determining whether to add the at least one physical layer identifier identified by the response to the neighbor cell list.

39. A computer-program product, comprising:
computer-readable medium comprising code for causing a computer to:
receive a handover message that indicates that an access terminal is being handed-over to a cell, wherein the handover message identifies at least one physical layer identifier; and
add the at least one physical layer identifier to a neighbor cell list for the cell as a result of receiving the handover message.

40. The computer-program product of claim 39, wherein the computer-readable medium further comprises code for causing the computer to send the neighbor cell list to the cell.

41. The computer-program product of claim 39, wherein the computer-readable medium further comprises code for causing the computer to:
provision the access terminal to conduct measurements to detect the at least one physical layer identifier; and
receive at least one measurement report message as a result of the provisioning, wherein the adding of the at least one physical layer identifier to the neighbor cell list comprises determining to add the at least one physical layer identifier to the neighbor cell list based on the at least one measurement report message.

42. The computer-program product of claim 39, wherein:
the computer-readable medium further comprises code for causing the computer to determine that the at least one physical layer identifier is associated with co-located cells operating on different frequencies; and
the at least one physical layer identifier is added to the neighbor cell list for the different frequencies based on the determination.

43. The computer-program product of claim 39, wherein:
the at least one physical layer identifier comprises a set of physical layer identifiers;
the computer-readable medium further comprises code for causing the computer to prioritize the set of physical layer identifiers; and
the adding of the at least one physical layer identifier to the neighbor cell list comprises including the prioritized set of physical layer identifiers in the neighbor cell list in a manner that indicates the prioritization.

44. The computer-program product of claim 39, wherein the computer-readable medium further comprises code for causing the computer to prioritize physical layer identifiers of the neighbor cell list based on at least one of: signal quality information associated with the at least one physical layer identifier during the handover, path loss information associated with the at least one physical layer identifier during the handover, registrations of idle access terminals at cells associated with the at least one physical layer identifier, information from events generated during the handover, how frequently the at least one physical layer identifier is reported in measurement report messages, or whether the at least one physical layer identifier is associated with a cell providing closed or hybrid access.

45. The computer-program product of claim 39, wherein the computer-readable medium further comprises code for causing the computer to:
send a message comprising an identifier associated with the cell to a network entity;
receive a response to the message from the network entity, wherein the response identifies at least one physical layer identifier of at least one cell in a neighborhood associated with the cell; and
determine whether to add the at least one physical layer identifier identified by the response to the neighbor cell list.
